(19) United States
(12) Patent Application Publication
(10) Pub. No.: US 2009/0225954 A1
(43) Pub. Date: Sep. 10, 2009

(54) X-Ray Collimators, and Related Systems and Methods Involving Such Collimators

(75) Inventors: Royce McKim, Austin, TX (US); Rodney H. Warner, Austin, TX (US)

Correspondence Address: O''Shea Getz P.C., 1500 MAIN ST. SUITE 912, SPRINGFIELD, MA, 01115, US

(73) Assignee: UNITED TECHNOLOGIES CORP., Hartford, CT (US)

(21) Appl. No.: 12/043,371

(22) Filed: Mar. 6, 2008

(51) Int. Cl. G21K 1/02

(52) U.S. Cl. 378/149; 378/147

(57) ABSTRACT

X-ray collimators, and related systems and methods involving such collimators are provided. In this regard, a representative X-ray collimator includes: a first member having channels located on a surface thereof; and a second member having protrusions located on a surface thereof; the first member and the second member being oriented such that the protrusions extend into the channels to define collimator apertures, each of the collimator apertures being defined by a portion of the first member and a portion of the second member.

### BACKGROUND

1. Technical Field

The disclosure generally relates to non-destructive inspection of components.

2. Description of the Related Art

Computed tomography (CT) involves the use of X-rays that are passed through a target. Based on the amount of X-ray energy detected at a detector located downstream of the target, information about the target can be calculated. By way of example, representations of target shape and density in three dimensions can be determined.

### SUMMARY

X-ray collimators, and related systems and methods involving such collimators are provided. In this regard, an exemplary embodiment of an X-ray collimator comprises: a first member having channels located on a surface thereof; and a second member having protrusions located on a surface thereof; the first member and the second member being oriented such that the protrusions extend into the channels to define collimator apertures, each of the collimator apertures being defined by a portion of the first member and a portion of the second member.

An exemplary embodiment of an X-ray system comprises: an X-ray source; and an X-ray collimator having a first member and a second member, the first member having channels located on a surface thereof, the second member having protrusions located on a surface thereof, the first member and the second member being oriented such that the protrusions extend into the channels to define collimator apertures, each of the collimator apertures being defined by a portion of the first member and a portion of the second member, each of the collimator apertures being aligned with the X-ray source.

An exemplary embodiment of a method involving an X-ray collimator comprises: providing a first member having channels located on a surface thereof; providing a second member having protrusions located on a surface thereof; and orienting the first member and the second member such that the protrusions extend into the channels to define X-ray collimator apertures.

Other systems, methods, features and/or advantages of this disclosure will be or may become apparent to one with skill in the art upon examination of the following drawings and detailed description. It is intended that all such additional systems, methods, features and/or advantages be included within this description and be within the scope of the present disclosure.

### BRIEF DESCRIPTION OF THE DRAWINGS

Many aspects of the disclosure can be better understood with reference to the following drawings. The components in the drawings are not necessarily to scale. Moreover, in the drawings, like reference numerals designate corresponding parts throughout the several views.

FIG. 1 is a schematic diagram depicting an exemplary embodiment of a system involving an X-ray collimator.

FIG. 2 is a schematic diagram depicting the embodiment of the X-ray collimator of FIG. 1, showing detail of the collimator members.

FIG. 3 is a schematic diagram depicting surface detail of the collimator members of an embodiment of an X-ray collimator.

FIG. 4 is a schematic diagram depicting the collimator members of FIG. 3 in an assembled orientation.

FIG. 5 is a flowchart depicting an exemplary embodiment of a method involving an X-ray collimator.

### DETAILED DESCRIPTION

X-ray collimators, and related systems and methods involving such collimators are provided, several exemplary embodiments of which will be described in detail. In this regard, collimators can be used, for example, in X-ray systems that are configured to perform non-destructive inspection of components. In such a system, X-rays are passed through a component and attenuation of the X-rays is measured by a set of detectors. A collimator is located upstream of the detectors to reduce the number of unwanted (e.g., scattered) X-rays reaching the detectors that can result in inaccurate measurements of X-ray attenuation. In some embodiments, such a collimator includes two members, with one of the members exhibiting channels and the other of the members exhibiting corresponding protrusions. The members are oriented so that the protrusions are received within the channels to form collimator apertures that are configured for enabling passage of X-rays. In some embodiments, the members are formed of tungsten, on which small surface features are conventionally considered difficult to form.

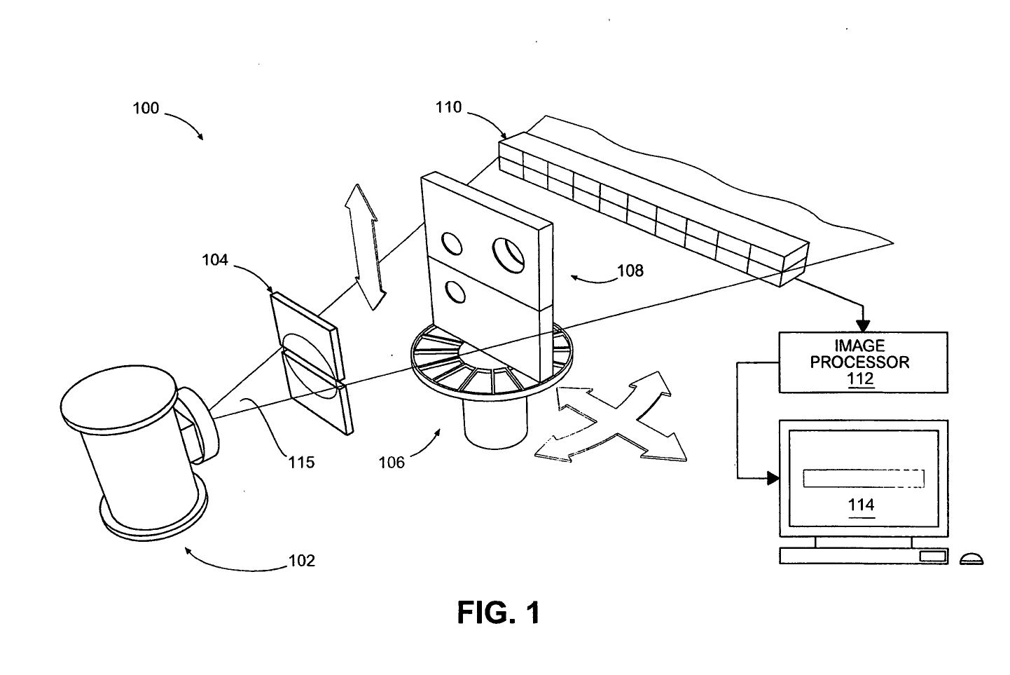

FIG. 1 is a schematic diagram depicting an exemplary embodiment of a system involving an X-ray collimator. As shown in FIG. 1, system 100 includes an X-ray source 102, a collimator 104, a turntable 106 on which a target 108 is positioned, a detector array 110, an image processor 112, and a display/analysis system 114. In operation, X-ray source 102 (e.g., a point source) is operative to emit X-rays. In this embodiment, the X-rays are emitted as a fan-shaped beam 115.

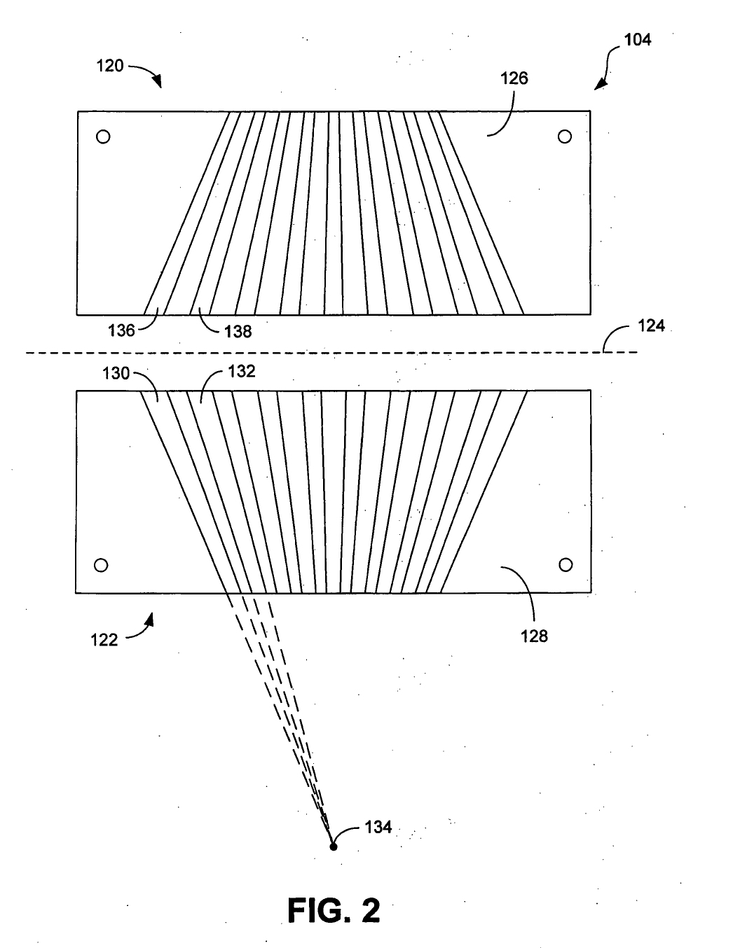

Collimator 104 is located downstream of source 102 and is formed of X-ray absorbing materials. In the embodiment of FIG. 1, tungsten is used although, in other embodiments, various other materials can be used such as brass or lead, for example. Details about an exemplary embodiment of a collimator will be described later with respect to FIG. 2.

Turntable 106 is a representative apparatus used for positioning a target, in this case, target 108. In operation, turntable 106 is movable to expose various portions of the target to the X-rays emitted by source 102. In this embodiment, turntable can be used to rotate the target both clockwise and counterclockwise, as well as to raise and lower the target. Altering of a horizontal position of the target in this embodiment is accomplished to expose different heights (e.g., horizontal planes) of the target to the fan-shaped beam. Notably, the elevation of the beam is fixed in this embodiment.

Detector array 110 is positioned downstream of the turntable. The detector array is operative to output signals corresponding to an amount of X-rays detected. In this embodiment, the array is a linear array, although various other configurations can be used in other embodiments.

Image processor 112 receives information corresponding to the amount of X-rays detected by the detector array and uses the information to compute image data corresponding to the target. The image data is provided to display/analysis system 114 to enable user interaction with the information acquired by the detector array.

FIG. 2 is a schematic diagram depicting collimator 104 of FIG. 1, showing detail of the collimator members. In particular, collimator 104 includes members (e.g., plates) 120, 122, with the members being separated in FIG. 2 by rotating member 120 about axis 124 to expose the sides of the members that normally contact each other when assembled. Specifically, when so assembled, side 126 of member 120 contacts side 128 of member 122.

Side 128 of member 122 incorporates a set of channels (e.g., channels 130, 132) that extend radially outwardly from a center 134, which is located at a point outside the periphery of member 122. Center 134 corresponds to a location at which the X-ray source 102 is to be positioned during operation. In contrast, side 126 of member 120 incorporates a set of protrusions (e.g., protrusions 136, 138) that are oriented so that each of the protrusions can be received by a corresponding one of the channels when the members are assembled. By way of example, in the assembled configuration, protrusion 136 extends into channel 130, and protrusion 138 extends into channel 132.

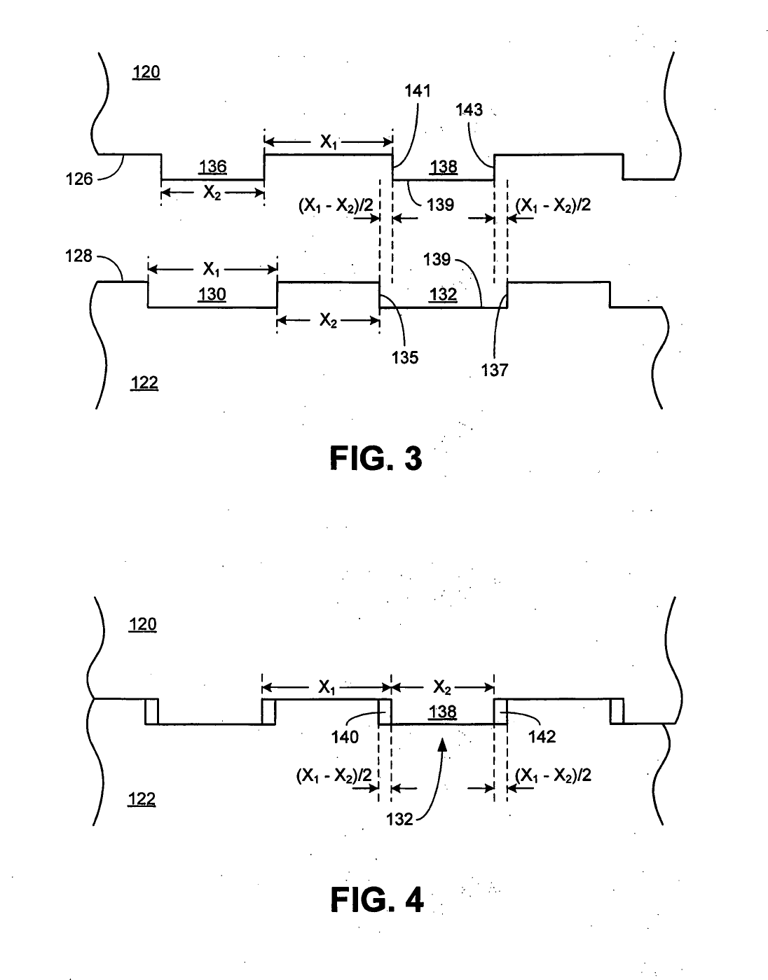

Relative positions of the channels and protrusions is shown in greater detail in FIGS. 3 and 4, which schematically depict members 120 and 122 in unassembled and assembled configurations, respectively. As shown in FIG. 3, each of the channels is defined by a floor and sidewalls extending from the floor. For instance, channel 132 is defined by a floor 133 and sidewalls 135, 137. Each protrusion is defined by an endwall and sidewalls extending from the endwall. For instance, protrusion 138 is defined by endwall 139 and sidewalls 141, 143.

Each of the channels exhibits a width X₁, with the spacing between adjacent channels being X₂. In contrast, each of the protrusions exhibits a width X₂, with the spacing between adjacent protrusions being X₁. As shown in the assembled configuration of FIG. 4, each of the protrusions extends into a corresponding one of the channels, with the endwall of each protrusion being positioned adjacent to (e.g., contacting) a floor of a corresponding channel.

The aforementioned sizing and spacing results in the formation of collimator apertures (e.g., apertures 140, 142), each of which exhibits a width of (X₁−X₂)/2. By way of example, a width X₁ of 2.0 mm and a width X₂ of 1.6 mm results in collimator apertures of 0.2 mm ((2.0−1.6)/2), with the spacing between adjacent apertures being 1.8 mm (center to center). Thus, in this embodiment, the collimator apertures exhibit widths that are an order of magnitude smaller that the channels used to form the apertures.

Formation of a collimator may be accomplished by providing a blank stock of metal (e.g., tungsten) that is sized for thickness, width and length. Slots are then rough cut using a cutting tool (e.g., a 2 mm carbide cutter) to form the final depth and rough width of slots. A final pass of the cutting tool is then used to finish the vertical edges of the slots. Notably, cutting tool offsets can be adjusted during cutting to accommodate variations attributable to cutter wear. By way of example, cutting tool offsets can be adjusted after approximately each 10 inches (254 mm) of cut in order to maintain the slot dimensions within specification. The slotted block than can be cut in half, such as by using a 0.75 inch (19 mm) wide slot located at the center of the block. Collimator channels are formed by mating the two halves of the block. In some embodiments, alignment features, such as dowel pins can be used to ensure proper and maintained alignment of the two halves.

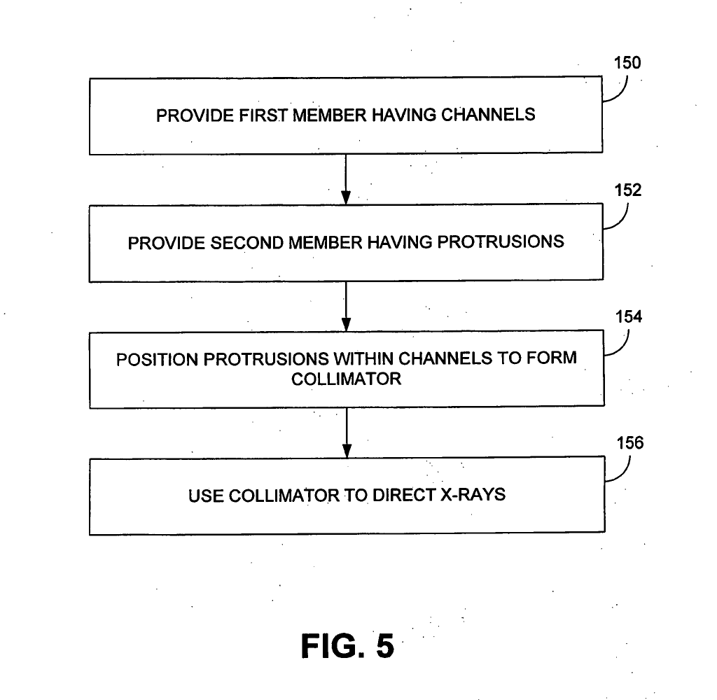

FIG. 5 is a flowchart depicting an exemplary embodiment of a method involving an X-ray collimator. As shown in FIG. 5, the method may be construed as beginning at block 150, in which a first member having channels is provided. In block 152, a second member having protrusions is provided. In block 154, the first member and the second member are oriented so that the protrusions extend into the channels to form an X-ray collimator having collimator apertures. In some embodiments, each of the channels of the first member exhibits a width that is at least approximately twice as wide as a width of each of the collimator apertures. In block 156, the collimator is used to direct X-rays at a target, such as for performing non-destructive inspection of the target to determine one or more of various characteristics. By way of example, the characteristics can include, but are not limited to, interior shape and density of the target. In some embodiments, the target can be a gas turbine engine component, such as a turbine blade.

It should be noted that a computing device can be used to implement various functionality, such as that attributable to the image processor 112 and/or display/analysis system 114 depicted in FIG. 1. In terms of hardware architecture, such a computing device can include a processor, memory, and one or more input and/or output (I/O) device interface(s) that are communicatively coupled via a local interface. The local interface can include, for example but not limited to, one or more buses and/or other wired or wireless connections. The local interface may have additional elements, which are omitted for simplicity, such as controllers, buffers (caches), drivers, repeaters, and receivers to enable communications. Further, the local interface may include address, control, and/or data connections to enable appropriate communications among the aforementioned components.

The processor may be a hardware device for executing software, particularly software stored in memory. The processor can be a custom made or commercially available processor, a central processing unit (CPU), an auxiliary processor among several processors associated with the computing device, a semiconductor based microprocessor (in the form of a microchip or chip set) or generally any device for executing software instructions.

The memory can include any one or combination of volatile memory elements (e.g., random access memory (RAM, such as DRAM, SRAM, SDRAM, VRAM, etc.)) and/or nonvolatile memory elements (e.g., ROM, hard drive, tape, CD-ROM, etc.). Moreover, the memory may incorporate electronic, magnetic, optical, and/or other types of storage media. Note that the memory can also have a distributed architecture, where various components are situated remotely from one another, but can be accessed by the processor.

The software in the memory may include one or more separate programs, each of which includes an ordered listing of executable instructions for implementing logical functions. A system component embodied as software may also be construed as a source program, executable program (object code), script, or any other entity comprising a set of instructions to be performed. When constructed as a source program, the program is translated via a compiler, assembler, interpreter, or the like, which may or may not be included within the memory.

The Input/Output devices that may be coupled to system I/O Interface(s) may include input devices, for example but not limited to, a keyboard, mouse, scanner, microphone, camera, proximity device, etc. Further, the Input/Output devices may also include output devices, for example but not limited to, a printer, display, etc. Finally, the Input/Output devices may further include devices that communicate both as inputs and outputs, for instance but not limited to, a modulator/demodulator (modem; for accessing another device, system, or network), a radio frequency (RF) or other transceiver, a telephonic interface, a bridge, a router, etc.

When the computing device is in operation, the processor can be configured to execute software stored within the memory, to communicate data to and from the memory, and to generally control operations of the computing device pursuant to the software. Software in memory, in whole or in part, is read by the processor, perhaps buffered within the processor, and then executed.

It should be emphasized that the above-described embodiments are merely possible examples of implementations set forth for a clear understanding of the principles of this disclosure. Many variations and modifications may be made to the above-described embodiments without departing substantially from the spirit and principles of the disclosure. By way of example, although channels are depicted as being associated with one member of a collimator while protrusions are depicted as being associated with another, some embodiments can include combinations of channels and protrusions one each member. All such modifications and variations are intended to be included herein within the scope of this disclosure and protected by the accompanying claims.

What is claimed is:

1. An X-ray collimator, comprising:
a first member having channels located on a surface thereof, each channel having a first channel sidewall; and
a second member having protrusions located on a surface thereof, each protrusion having a first protrusion sidewall;
the first member and the second member being oriented such that the protrusions extend into the channels to define collimator apertures, at least one of the collimator apertures being defined between the first channel sidewall of one of the channels and the first protrusion sidewall of one of the protrusions.

2. The collimator of claim 1, wherein:
each channel further comprises a second channel sidewall;
each protrusion further comprises a second protrusion sidewall; and
at least one of the collimator apertures is defined between the second channel sidewall of one of the channels and the second protrusion sidewall of one of the protrusions such that at least one of the protrusions and a corresponding one of the channels defines two of the collimator apertures.

3. The collimator of claim 1, wherein each of the channels and the protrusions is radially aligned with a center located outside respective peripheries of the first member and the second member.

4. The collimator of claim 1, wherein each of the channels exhibits a width that is at least approximately twice as wide as a width of each of the collimator apertures.

5. The collimator of claim 4, wherein each of the channels exhibits a width that is approximately ten times as wide as a width of each of the collimator apertures.

6. The collimator of claim 1, wherein:
a first of the channels has a floor, the first channel sidewall of the first channel extending outwardly from the floor;
a first of the protrusions has an endwall, the first protrusion sidewall of the first protrusion extending outwardly from the endwall; and
the first protrusion and the first channel are configured such that alignment of the first member and the second member results in the first protrusion extending into the first channel with the endwall contacting the floor.

7. The collimator of claim 1, wherein the first member and the second member are formed of metal.

8. The collimator of claim 7, wherein the first member and the second member are formed of tungsten.

9. An X-ray system, comprising:
an X-ray source; and
an X-ray collimator comprising
a first member having channels located on a surface thereof, each channel having a first channel sidewall;
a second member having protrusions located on a surface thereof, each protrusion having a first protrusion sidewall; and
the first member and the second member being oriented such that the protrusions extend into the channels to define collimator apertures, at least one of the collimator apertures being defined between the first channel sidewall of one of the channels and the first protrusion sidewall of one of the protrusions.

10. The system of claim 9, wherein each of the channels exhibits a width that is at least approximately twice as wide as a width of each of the collimator apertures.

11. The system of claim 9, wherein each of the channels and the protrusions is radially aligned with a center located outside respective peripheries of the first member and the second member.

12. The system of claim 9, wherein a portion of each of the protrusions contacts a corresponding portion of each of the channels.

13. The system of claim 9, wherein:
each channel further comprises a second channel sidewall;
each protrusion further comprises a second protrusion sidewall; and
at least one of the collimator apertures is defined between the second channel sidewall of one of the channels and the second protrusion sidewall of one of the protrusions such that at least one of the protrusions and a corresponding one of the channels defines two of the collimator apertures.

14. The system of claim 9, further comprising:
an X-ray detector array located downstream of the collimator and aligned with the collimator apertures, the X-ray detector being operative to output signals corresponding to an amount of X-rays detected; and
an image processor operative to receive information corresponding to the amount of X-rays detected and to provide image data corresponding to a target at which the X-rays are directed.

15. The system of claim 9, further comprising a target located downstream of the collimator and aligned with the collimator apertures such that a portion of the X-rays emitted from the X-ray source are directed through the collimator apertures and are incident upon the target.

16. A method for orientating an X-ray collimator, the method comprising:
providing a first member having channels located on a surface thereof, each channel having a first channel sidewall;
providing a second member having protrusions located on a surface thereof, each protrusion having a first protrusion sidewall; and
orienting the first member and the second member such that the protrusions extend into the channels to define X-ray collimator apertures, at least one of the collimator apertures being defined between the first channel sidewall of one of the channels and the first protrusion sidewall of one of the protrusions.

17. The method of claim 16, wherein the step of orienting further comprises orientating the first and the second members to define at least one of the collimator apertures between a second channel side wall of one of the channels and a second protrusion sidewall of one of the protrusions such that at least one of the protrusions and a corresponding one of the channels defines two of the collimator apertures.

18. The method of claim 16, wherein providing the first member comprises forming the channels in the surface of the first member such that each of the channels exhibits a width that is at least approximately twice as wide as a width of each of the collimator apertures.

19. The method of claim 16, further comprising using the collimator to direct X-rays at a target.

20. The method of claim 19, wherein the target is a gas turbine engine component.
